(19) United States
(12) Patent Application Publication
(10) Pub. No.: US 2018/0207573 A1
(43) Pub. Date: Jul. 26, 2018

(54) LONG LIFE FILTER

(71) Applicant: ENVERID SYSTEMS, INC., NEEDHAM, MA (US)

(72) Inventors: SHARON PERL-OLSHVANG, PARDES HANNA (IL); UDI MEIRAV, NEWTON, MA (US); SHAWN BROWN, WAKEFIELD, MA (US)

(73) Assignee: ENVERID SYSTEMS, INC., NEEDHAM, MA (US)

(21) Appl. No.: 15/489,539

(22) Filed: Apr. 17, 2017

Related U.S. Application Data
(60) Provisional application No. 62/449,587, filed on Jan. 23, 2017.

(51) Int. Cl. B01D 50/00; B01D 45/16; B04C 3/00; B01D 46/00; B01D 46/52; B01D 46/10

(52) U.S. Cl. CPC B01D 50/002; B01D 45/16; B01D 46/10; B01D 46/0027; B01D 46/521; B04C 3/00

(57) ABSTRACT

A filter comprising a housing, frame or boundary, a plurality of cyclonic-element arrays and a plurality of individual airflow paths is disclosed herein. In some embodiments, the filter is configured to be arranged or otherwise exposed to an upstream side of an airstream, and the cyclone element arrays are configured to separate particles entrained in the airstream. The plurality of cyclonic-element arrays may be organized in a parallel or approximately parallel arrangement, and the plurality of individual airflow paths may correspond to the plurality individual of cyclone elements in each array life.

### CROSS REFERENCE TO RELATED APPLICATIONS

This application claims priority to U.S. Provisional Patent Application No. 62/449,587, filed Jan. 23, 2017, entitled “Long Life Air Filter Based on Microfluidic Plastic Media”, the entire disclosure of which is incorporated by reference herein in its entirety.

### TECHNICAL FIELD

Embodiments of the present disclosure relate generally to apparatuses, systems and methods for filtration, and more particularly, to filtrations in ventilation and cooling systems, as well as to replaceable filters that are embedded in filtration systems.

### BACKGROUND

Most ventilation systems include air filters, whose primary role is to capture suspended particles and prevent them from proceeding in an airstream. There is a large variety of filter types and brands, but they all operate on a similar principle where a permeable medium allows air to flow through, while particulate matter that is suspended in the air is captured within the medium. Many of these media are based on woven or non-woven fibers of various types and densities. Over the operating life of the filter, particulate matter accumulates in the medium, gradually degrading its permeability. Such filters typically require frequent replacement, which leads to recurring expenses of purchasing replacement filters, disposing the old filters and the time and effort associated with the frequent replacement. Furthermore, the filters' performance deteriorates as captured particulate matter builds up in the media.

Media filters are frequently configured as standard, easy-to-replace parts that are shaped and sized to fit the ventilation system into which they are inserted, or vice versa, ventilation systems are designed to accept a standard filter from among a group of widely accepted standard filter sizes. In particular, many filters are standardized to certain rectangular dimensions and thicknesses, allowing the operator to acquire replacement filters from any number of different manufacturers who produce such replacement filters to established dimensions and specifications.

Cyclonic separators have the capacity to remove and capture solid particles from an airstream, using a different mechanism than media filters. In cyclonic separators, air enters a cavity at a high velocity through a tangential inlet and in an orientation that is horizontal (relative), namely in a plane that is perpendicular (relative) to the vertical axis (relative) of the cavity. The airflow in the cavity forms a vortex and the resultant centrifugal forces push suspended particles towards the wall of the cavity. Air exits the cavity through a central axial outlet, and the particulate matter collects at the bottom of the cavity. Cyclonic separators in their conventional form are not suitable for use as a filter in ventilation systems for at least functional reasons, as well as for reasons of form, shape and size.

### SUMMARY OF SOME OF THE EMBODIMENTS OF THE DISCLOSURE

Embodiments of the present disclosure address the shortcomings of current filtration systems, in particular (and for example), current filters in use for ventilation systems. Accordingly, the embodiments of the present disclosure present apparatuses, systems and methods for filtration, and more particularly, to filtrations in ventilation and cooling systems, as well as to replaceable air filters (for example).

In some embodiments, a filter is provided (e.g., an air filter), which includes a plurality of cyclonic-element arrays each comprising a plurality of cyclonic-elements, and a plurality of individual airflow paths corresponding to the plurality individual of cyclone elements in each array.

Such embodiments may include one and/or another, several (various combinations), or all of the following clarifications, structure, and/or functionality (as the case may be), and thus, establish a multitude of other embodiments by the inclusion and various alternative combinations thereof:
each cyclonic element comprising a cylindrically-symmetric cavity having a tangential airflow inlet and an axial airflow outlet;
the plurality of cyclonic-element arrays can be:
   arranged in an organized fashion within and/or supported by a frame or a housing, together forming an assembly, and/or
   arranged in an organized fashion and assembled or otherwise connected together to form an assembly such that a boundary or edge is formed by sides of the arrays arranged on a perimeter of the assembly;
   and
   the assembly can have an upstream side configured to receive an airstream for filtering such that the tangential airflow inlets of the cyclonic elements of the arrays receive the airstream, and a downstream side;
the cyclonic elements in each array can be attached to each other directly and/or via a connecting material;
the cyclonic elements in each array can be attached to a first sheet of material;
the cyclonic elements can form a common surface or barrier that separates the upstream side from the downstream side of the assembly;
the downstream side of the assembly can be in airflow communication with the airflow outlets of the cyclonic elements of the array;
each airflow path can corresponding to a respective cyclone element and can comprise the path established from a respective airflow inlet, through a respective cavity, and to a respective airflow outlet;
the airstream entering the assembly from the upstream side can flow through the plurality of cyclone elements of each array via the plurality of corresponding airflow paths, and can be expelled via the downstream side of the assembly;
the connecting material can be the same material that comprises the walls of the cyclonic elements;
the connecting material can comprise the walls of the cyclonic elements;
the plurality of arrays can be configured with a plurality of receptacles configured to receive and retain particles separated from the airstream by the cyclonic elements;
a depth h of each receptacle (see above) can be between 2-50 mm, or can be between 3-20 mm;
the frame, housing or boundary can be rectangular or approximately rectangular;
a thickness T between approximately 10 mm-200 mm;
an inner diameter d of the cavity of a cyclonic element at its widest point can be less than 10 mm, less than 5 mm, or less than 2 mm;
a plurality of parallel or approximately parallel planar segments each oriented perpendicular or approximately perpendicular to a plane of the filter;
a plurality of parallel or approximately parallel planar segments each oriented at an angle greater than 30 degrees relative to a plane of the filter;
the plurality of arrays can be configured in a plurality of layers, and each layer can be configured as an integral plastic monolith;
each array can include a length, width and height, with the length and/or width being greater than the height;
each array can be arranged such that the height (see above) is perpendicular or approximately perpendicular to the flow direction of the airstream;
the plurality of arrays of the assembly can be arranged parallel or approximately parallel to each other;
the assembly can be arranged such that when in a first position (e.g., vertical), the plurality of arrays are perpendicular or approximately perpendicular (e.g., horizontal) to the first position;
the filter further comprises connecting material configured to guide and/or constrain the airstream to the airflow inlets of the plurality of cyclonic elements of each array such that the airstream flows through the plurality of individual airflow paths of the cyclonic elements;
the connecting material comprises one or more second sheets of material;
the filter includes no other airflow pathways other than the plurality of individual airflow paths;
the frame, housing or boundary can be configured as a wall of a cylindrical-tube, such that one of the upstream side and downstream side of the assembly corresponds to the outer circumference of the cylindrical-tube, and the remaining side of one of the downstream side and the upstream side comprises the inner circumference of the cylindrical-tube, and the airstream traverses between the outer circumference and the inner circumference radially to be filtered.

In some embodiments, “cylindrically-symmetric” corresponds to any structure which includes a rotational or axial symmetry.

In some embodiments, a method for increasing the lifespan or a replacement cycle time of an air filtration system having a filter or a plurality of such filters is disclosed. The method comprises, replacing an original or an existing filter with a replacement filter according to any one of the filter embodiments disclosed herein (such as those described above); or, by arranging additional filters according to any one of the filter embodiments disclosed herein (such as those described above), adjacent to or upstream of a plurality of the existing filters of the air filtration system.

### BRIEF DESCRIPTION OF THE DRAWINGS

The principles and operations of the systems, apparatuses and methods according to some embodiments of the present disclosure may be better understood with reference to the drawings, and the following description. These drawings are given for illustrative purposes only and are not meant to be limiting.

FIGS. 1A and B are a schematic ventilation system and a removal filter (FIG. 1A) and a single filter (FIG. 1B), constructed and operative according to some embodiments of the present disclosure;

FIGS. 2A and 2B are a schematic filter (FIG. 2A) comprising a monolithic array of miniature cyclonic elements (FIG. 2B), constructed and operative according to some embodiments of the present disclosure;

FIGS. 3A and 3B are each an exemplary individual cyclonic element of the array, configured with a receptacle for separated particles, constructed and operative according to some embodiments of the present disclosure;

FIGS. 4A and 4B are a single receptacle shared by multiple cyclonic elements in the array and enclosed by a housing or frame, such term used interchangeably throughout the disclosure (FIG. 4A), and shown without the frame (FIG. 4B), constructed and operative according to some embodiments of the present disclosure;

FIGS. 5A and 5B are two different receptacle depths for otherwise-similar cyclonic elements, constructed and operative according to some embodiments of the present disclosure;

FIG. 6 is a schematic multiple array segment combined to form a single coplanar filter by attachment to a common frame, constructed and operative according to some embodiments of the present disclosure;

FIGS. 7A and 7B are filters in a V-bank configuration (7A) and a tilted receptacle element (7B) that can be used in such a configuration, constructed and operative according to some embodiments of the present disclosure;

FIGS. 8A and 8B are multi-array stack filters where the arrays are not coplanar with the filter itself. FIG. 8A shows a stack where the arrays are at a 90-degree angle to the filter. FIG. 8B shows a stack where the arrays are at a 45-degree angle to the filter, constructed and operative according to some embodiments of the present disclosure; and

FIG. 9 is a section of a filter comprising a plurality of stacks where each stack has three layers, where each an array of cyclonic elements, and the multiple stacks, are coplanar with each other, constructed and operative according to some embodiments of the present disclosure.

### DETAILED DESCRIPTION OF SOME OF THE EMBODIMENTS

The following detailed description provides details for some of the disclosed embodiments, particularly those with respect to filters, which include arrays of cyclonic elements. Such filters, according so some embodiments, are configured to prevent passage of gas/air through the filters except via paths that traverse from the cyclone elements—i.e., via tangential inlets, through the cyclonic elements, and exiting out concentric axial outlets.

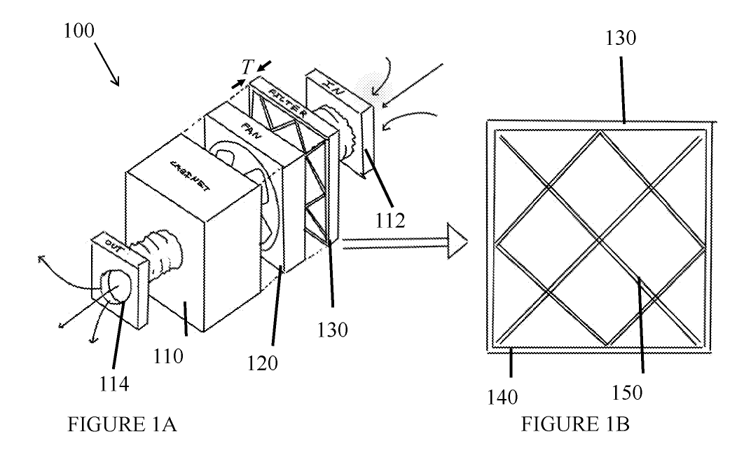

FIG. 1A shows a schematic of an exemplary ventilation system 100, to which filters according to any of the disclosed embodiments can be used. The system (according to some embodiments), comprises a cabinet 110, a fan 120, an inlet 112, an outlet 114, and a filter 130. The system 100 may include a plurality of fans and a plurality of filters, and the filters can be positioned, with respect to the direction of an airstream, before (upstream of) the fan 120 or after (downstream of) the fan 120. Other components can be configured with/in the system, such as electric heaters, refrigerant coils, (not shown), etc.

Filter 130 is shown separately in FIGS. 1B and 1s shaped as a rectangular element (for example), typically with a distinct housing/frame 140, and can include a layer(s) of filtration medium such as, but not limited to, a non-woven fiber and/or air-permeable paper or cloth. As noted earlier, the terms “housing”, “frame” and “boundary” may be used interchangeably throughout the disclosure, such that, in some embodiments, a housing may be a container configured to receive an airstream and expel the airstream with the filtering media component(s) provided inside, a frame that surrounds all or at least a portion of filtering media component(s) (e.g., arrays—see below), or even a physical boundary (i.e., the edges of the material that forms the filter media component(s). For example, in some embodiments, where the filter media component(s) is sufficiently rigid, and thus, the frame can be defined by the boundary of the media without requiring additional housing/frame material to support the media.

The filter frame or housing 140 of the filter defines a first surface (e.g., side, upstream side) through which air enters the filter 130, and a second surface (e.g., side, downstream side) through which air exits the filter 130. In some embodiments, these two surfaces are parallel (or approximately parallel), and can be (often) planar. In some embodiments, the filters 130 may be formed as a non-planar structure.

In some embodiments, filters 130 includes a permeable sheet of paper which may be pleated/folded in an accordion-like fashion to increase the amount of surface for exposure to an airstream. The filtration performance of the filters can be controlled by varying properties of the permeable sheet such as the pleating density, the paper type, etc., of the permeable sheet. The frame 140 can be formed of cardboard, plastic, metal, rubber, and/or any other suitable material. The frame 140 can support the medium along the edge. Further support may be provided by cross beams 150 or a rigid screen placed within the medium. These serve to keep the filter media in place and support and maintain the form and shape of the media in the filter 130. Other filter shapes may be utilized, including non-rectangular flat shapes, such as a circular disc, or a non-flat shape such as hollow cylindrical filters, which allow air to flow axially into the cylindrical space and radially through the medium.

In some embodiments, the frame 140 is supported by the cabinet 110, and held in a location and orientation such that the air flows through the filter 130 urged by the fan 120. The filter 130 and the cabinet 110 may be further configured so that the filter 130 can easily be removed and replaced by a similar, filter 130 as needed (e.g., a new filter). In a non-limiting example, a slot is configured in the cabinet 110 allowing the filters 130 to slide in and out on guides or rails that match the filter 130. In some embodiments, a hinged or removable lid or cover is configured to be opened and to allow filters 130 to be removed and replaced.

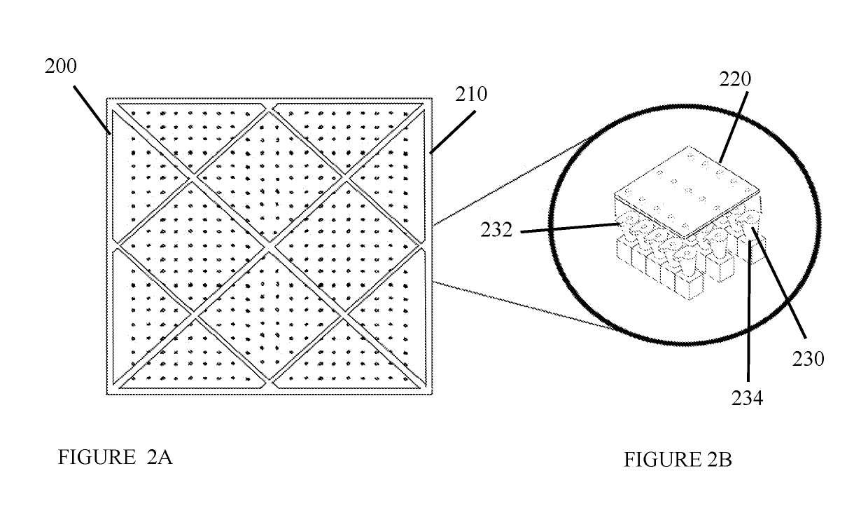

FIG. 2A shows another example filter 200 embodiment accordingly comprising a monolithic planar array 220 of cyclonic cavity elements 230, each corresponding to a volume of approximately 15-30 cubic millimeters attached to each other. Here the term “monolithic” implies molded, manufactured or otherwise formed out of one (e.g., solid, congruent) piece of material, for example, parts produced via plastic injection molding, machining (e.g., metal), or any other manufacturing method and corresponding material that can be formed into a single piece with multiple cyclonic elements (as well as, in some embodiments, a single piece of multiple arrays having a plurality of cyclonic elements). This contrasts with a product where each element/component is formed separately and subsequently the elements are assembled together (e.g., fasteners, welding, adhesive) to form the final product. In some embodiments of the present disclosure, separate manufacture of components and assembly thereof can be used.

The filter 200 can include a rectangular shape (as an example embodiment), but can have any shape including irregular or regular (e.g., circular, square, etc.) shapes. FIG. 2B shows an expanded close up view of a section of the array 220. Each cyclonic element can further comprise a tangential inlet 232, and a concentric outlet 234, and are configured (in some embodiments) such that some or all the inlets 232 are in fluid communication with a first side of the array (or filter) and some or all the outlets 234 are in fluid communication with the other side of the array 220 (or filter). In some embodiment, a second inlet may be positioned in a non-tangential position and be in fluid communication with the tangential inlet of the cavity.

In some embodiments a thickness of the filter (defined, for example, as the average separation distance between the two opposite planar surfaces of the filter (e.g., Tin FIG. 1A)) can be in the range from 10 mm to 200 mm, from 15 mm to 180 mm, from 20 mm to 160 mm, from 40 mm to 140 mm, from 60 mm to 120 mm, 80 mm to 100 mm, including values and subranges therebetween.

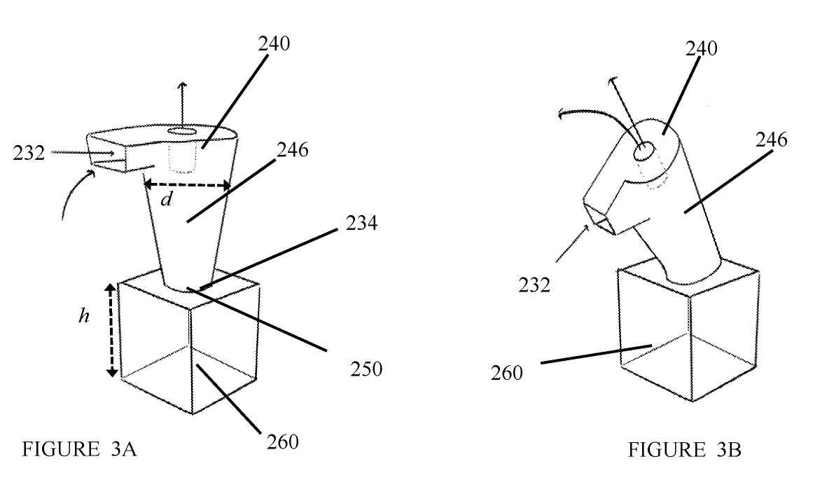

FIGS. 3A and 3B show schematic illustrations of example embodiments of a single cyclonic element 240 of the array 220 (FIG. 2B). Each element 240 in the array 220 may comprise walls that are symmetric (or approximately symmetric) about an axis and define a cavity 246 having the shape of a cylinder, a cone or a hybrid structure. For example, the cavity 246 may have a conical shape with a changing diameter d along the axis of the cavity 246. In some embodiments, the cyclonic elements 240 may have one or more additional openings for the expulsion of solid particles.

In some embodiments, receptacles are provided and configured to receive particles separated from an airstream by the cyclone element 240. For example, as shown in FIG. 3A, a particle outlet 250 can be located around the bottom tip of the cavity 246 and a receptacle or compartment 260 can be attached therein.

In some embodiments, the receptacle 260 may be positioned at an angle relative to the cylindrical axis of the cavity 246 (FIG. 3B), i.e., the axis of the cavity 246 may not align with a major axis of the receptacle 260. The receptacle 260 may have any shape, provided the receptacle is sized and shaped to receive particles expelled from the cavity of a cyclonic element 240. For example, the receptacle 260 may be a box with a depth h ranging from 2 mm to 50 mm, from 3 mm to 35 mm, from 5 mm to 20 mm, from 6 mm to 10 mm, including values and subranges therebetween.

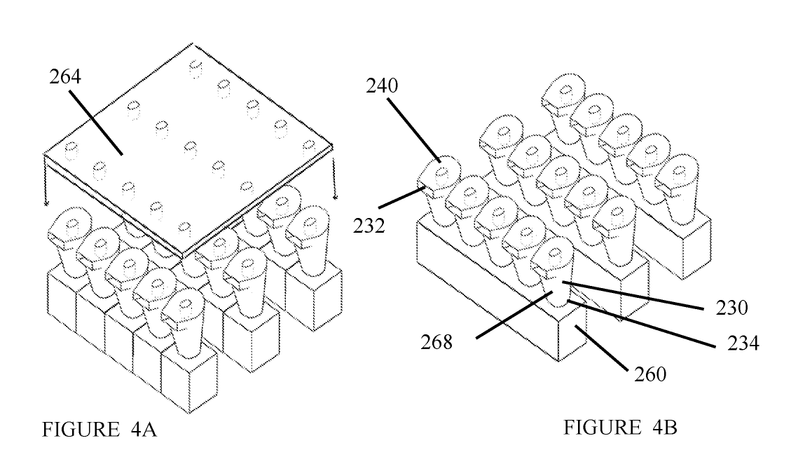

In some embodiments, such as shown in FIGS. 3A and 3B, a separate receptacle is attached to each cyclonic element 240. In some embodiments, shown in FIG. 4B, a single receptacle 260 can be shared by a plurality of cyclonic elements 240. In some embodiments, an array of cyclonic elements 240 may include a combination of cyclonic elements each attached to a single receptacle and a plurality of cyclonic elements sharing a single receptacle.

FIGS. 4A and 4B show example embodiments of an array of cyclonic elements for filters. Such embodiments may be obtained by, for example, densely-packing cyclonic elements 240 into a monolith such that little or no gaps exist between the cyclonic elements to allow air or gas to seep in between the cyclonic elements 240 (FIG. 4B). As another example, the cyclonic elements 240 can be attached to a common sheet or surface 264 (FIG. 4A) that can hold the elements in place, and can also prevent air from flowing through the array except via the path from the tangential inlets 232 to the axial outlets 234 (via the cavities). The sheet 264 may have topographical features (e.g., not be entirely flat). The surface 264 may comprise any surface/sheet-like member, and in some embodiments, is impermeable.

In some embodiments, the dense-packing of cyclonic elements 240 into a filter for use in custom or existing air treatment systems can be facilitated by the miniature size of the cyclonic elements 240. For example, the overall height of the entire cyclonic element 240 can range from 0.5 mm to 25 cm, from 1 mm to 20 cm, from 50 mm to 15 cm, from 500 mm to 15 cm, from 1 cm to 10 cm, from 5 cm to 10 cm, including values and subranges in between. Such small sizes allows for packing a large number of cyclonic elements into a portable filter that has a small footprint, facilitating the use of such filters in standard air cleaning systems. In some embodiments, the cyclonic elements 240 can be sized based on the size of the particles that are slated for removal from the airflow. For example, larger cyclonic separators are generally ineffective at separating fine particles, as the centrifugal force in such cyclones is insufficient to effectively sequester very fine or light particles. A larger centrifugal force to separate out even finer particles from an airstream may be attained by reducing the size of the each cyclonic element in the filter while maintaining a constant (or approximately constant) linear velocity for the airstream (since the centrifugal force is inversely proportional to the radius of curvature of the circular motion). Thus, in some embodiments, a large number of small cyclones may carry a comparable airstream as one larger cyclone, while producing much higher separation force and thus provide far superior filtration of fine particles, in some embodiments. With the cyclonic elements, and the filters containing such elements, as disclosed herein, particles with size (e.g., average radius) in the micron range (e.g., from 0.01 micron to 0.1 micron, from 0.1 micron to 1 micron, from 1 micron to 10 microns, exceeding 10 microns, including values and subranges therebetween, may be separated out from an airstream.

In some embodiments, the linear velocity of the airstream may be controlled using a fan 120 or a pressure differential, similar to that shown in FIG. 1A. Under such pressure, the airstream can be forced to traverse the array by entering the inlets 232 of the cyclonic elements 240. As air enters the tangential inlet 232 of any cyclonic element, its momentum causes it to circulate and form a vortex. Air exits the cavity 230 out through the concentric, axial outlet 234, which may be further configured with a tube that extends along the axis into the cavity 230. However, the circulation creates a centrifugal force large enough to push suspended particles in the airstream to the outer wall 268 of the cyclonic cavity, leading to the separation and collection of the suspended particles into a receptacle 260. By controlling the linear velocity of the airstream (via a pressure differential, for example) and the size of the cyclonic elements (e.g., by reducing radius of the conical cavity of the cyclonic element), in some embodiments, the separation and collection of particles (including finer particles) from an airstream may be efficiently accomplished. Moreover, in some embodiments, can be customized for a particular application. Accordingly, cyclone element 240 cleans the airstream while the separated particles accumulate in the receptacle. In some embodiments, as long as the receptacle is not full, the cyclone element 240 can continue to function effectively in separating particles from the incoming airstream.

An extended operating lifetime is enabled, with some embodiments of the present disclosure, by having sufficiently large receptacles 260, which take a long time to fill. While the horizontal cross section (or footprint) of each receptacle 260 is limited by the neighboring cyclones and their respective receptacles 260, the vertical dimension, or depth, of the particle receptacles 260, can be made as large as necessary thereby increasing their volume and extending the usable service life of the filter as much as needed. Further, in some embodiments, a plurality of the receptacles may be configured as a combined unit that may be removable separate from the cyclonic cavities.

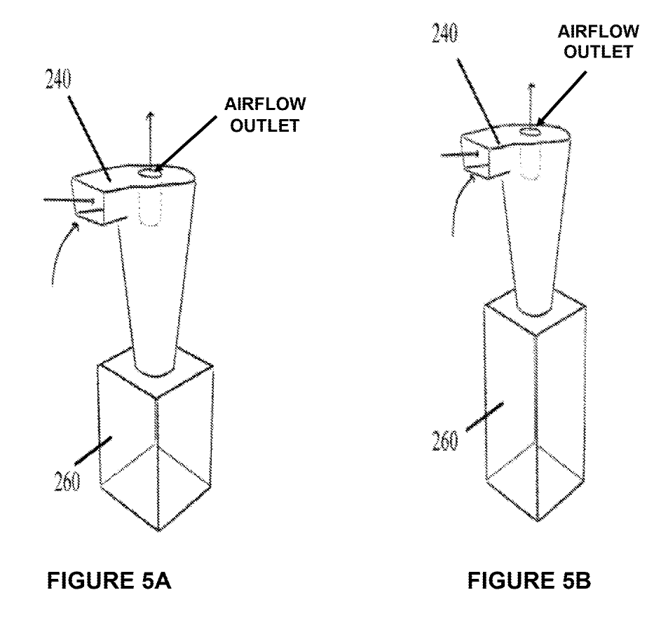

FIGS. 5A and 5B show a schematic illustration of two similar cyclone elements with similar receptacle footprints but different receptacle depths. The element on the right (5B) has a receptacle 260 that is approximately twice the depth and volume of the one on the left (5A), as a result, a filter configured with an array based on the cyclone element of FIG. 5B will have approximately twice the useful operating life.

In the following non-limiting example, the filtration of outside air with relatively high pollution levels is described. Particulate matter (PM) is typically measured in micrograms per cubic meter (μg/m³) or nanograms per liter (ng/liter), which are the same units. An outdoor PM level of 100 is considered high, but not unusual, in some of the world's more polluted cities. In one embodiment of the cyclonic filter array, each cyclone has a footprint of 10 mm² and under the intended operating conditions of static pressure of 0.25″ Water Gauge (WG) induced by a fan, it carries approximately 0.1 liters per minute. If the cyclone elements separate virtually all the PM and eject them to the receptacle, the rate of mass accumulation in the receptacle, Rₘ, would be:

Rₘ=0.1 liter/min×100 ng/liter=10 ng/min=600 ng/hour

In the maximum workload example of 24 hours, 365 days a year, namely 8,760 hours per year, the annual rate of mass accumulation in each receptacle is:

Rₘ=600 ng/hour×8760 hours/year=5.3 milligrams/year

In this example and under these conditions, for a 10 year operating life the particle receptacle has to have the capacity for 53 milligrams. The volume of this accumulation would depend on the density of the particles, but for particles that are approximately the density of water, 1 mg/mm³, that would imply 50 mm³ volume. The dust receptacle for a single cyclone has a footprint approximately matched to the cyclone element, 10 mm², so it would need to be approximately 5 mm deep to provide for a 10 year lifetime.

In a further embodiment of this example, a heating, ventilation and air-conditioning (HVAC) replaceable filter would have a surface area in the range from 30-90 cm square, 40-80 cm square, 50-70 cm square, 60 cm square, including values and subranges therebetween, and a thickness that is in the range of from 10 mm to 50 mm, from 15 mm to 40 mm, from 20 mm to 30 mm, 25 mm, including values and subranges therebetween. The cyclonic cavity elements would be between 5 mm to 15 mm, between 7 mm to 13 mm, between 9 mm to 11 mm, 10 mm, including values and subranges therebetween, in height excluding the receptacle. A receptacle of between 10 20 mm can be attached while still maintaining a target thickness of under 25 mm, under 20 mm, under 15 mm, including values and subranges therebetween for the cyclone array sheet. This example can be utilized to calculate the required bin depth for other operating conditions and required lifetimes.

More generally, the depth of the receptacles can be made larger to accommodate more particle volume, or smaller to produce a thinner or lighter filter. In some embodiments, the receptacle depth can be between 1 mm to 100 mm, between 1 mm to 75 mm, between 1 mm to 50 mm, between 2 mm to 50 mm, between 2 mm to 30 mm, between 3 mm to 20 mm, between 5 mm to 18 mm, between 7 mm to 16 mm, between 9 mm to 14 mm, including values and subranges therebetween.

The filter may comprise more than one monolithic array. In some embodiments, a plurality of monolithic arrays can be combined into segments, to form a filter of the required form and dimensions. Multiple array segments can be attached in a number of configurations and using a number of techniques.

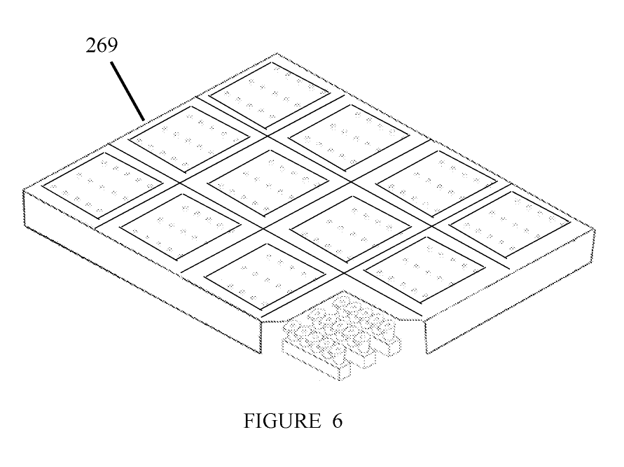

Multiple arrays of cyclonic elements can be combined in a co-planar configuration, for example, to form a larger, single planar filter. Such an approach allows a manufactured array module to be used to form a variety of different sizes of a planar filter. The arrays can be attached using any suitable technique, including but not limited to adhesives, clips, direct mechanical attachment, fasteners, or welding. The individual arrays may be attached to a common frame/housing 269, as shown in FIG. 6, or directly attached to each other. In some embodiments, the individual arrays maybe attached removably (or irremovably) to the common frame or each other.

Alternatively, multiple array segments can be combined in a non-coplanar configuration. For example, segments can be parallel to each other but not in the same plane. Such configuration can be seen as analogous to pleating of ordinary paper filters, where each array segment is analogous to a single pleat, as described herein.

The orientation of the filter may depend on the system in which it is placed. In general air flow at the surface of the array in a direction that is perpendicular to the array's geometric surface. In some filtration systems, a flat filter is placed in a horizontal orientation, where air flows vertically through the filter. In other cases, filters can be positioned in a vertical orientation where the airflow is horizontal. In other instances, filters are oriented in an angle with respect to the direction of gravity. The latter can be the case for any number of reasons. For example, the airflow direction required by the system may be at such an angle, or the filtration system may be mobile or portable and be required to operate as it is moved. Air filters in vehicles, vessels and aircraft may be such an example.

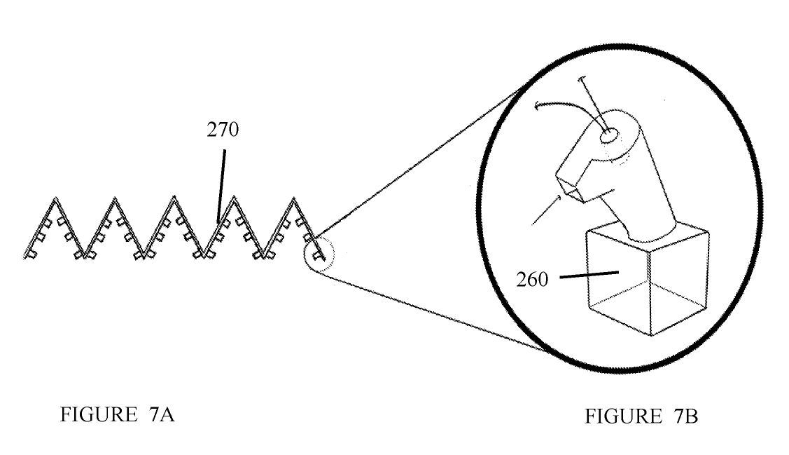

Yet in other cases, multiple filters are combined in a so-called V-bank or zigzag configuration 270, shown in FIG. 7A. The orientation relative to gravity can have an influence on the performance of cyclonic separators as gravity helps draw the separated particles into the receptacle 260 and keep them in the receptacle 260. However, the receptacle form can be designed to address operation in non-vertical orientation. In a non-limiting example, illustrated in FIG. 7B, the receptacle 260 (and/or the cavity) can be set at an angle relative to the sheet array plane, so that when the filter is orientated at an angle, the receptacles 260 become vertical (or approximately vertical). For example, the receptacle 260 can be oriented at an angle of 5°, 10°, 15°, 20°, 25°, 30°, 35°, 40°, 45°, including values and subranges therebetween, with respect to the sheet array plane.

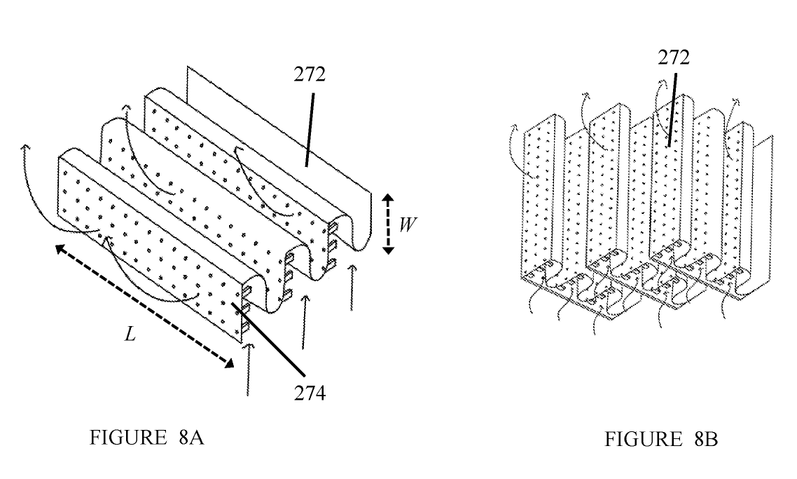

In another embodiment, shown in FIGS. 8A and 8B, a generally flat or planar filter comprises connected array segments, where each segment is at an angle relative to the filter plane. FIG. 8A shows a side view of a segmented array filter 272 where each segment 274 is at a 90-degree angle (or approximately thereto) relative to the filter plane. The array segments essentially form a parallel stack with appropriate barriers to prevent air from flowing between the individual arrays segments. Since the axes of the cyclone elements 240 are perpendicular (or approximately thereto) to the array surface in each segment 274, they are parallel to (or approximately parallel to), or in-plane with, the filter plane. In this example, when the filter is positioned vertically (or approximately vertically), the cyclone elements 240 and the receptacles 260 are in the conventional orientation, namely the receptacle 260 is positioned underneath the cyclone element 240. To allow the required airflow through the cyclone elements 240, connecting surfaces or partitions can be attached to the segments as shown schematically in FIG. 8A, preventing air from flowing across the filter other than through the cyclonic elements inlets.

In a configuration of parallel array stack at 90-degrees (or approximately thereto) to the filter, the width of the array in large part determines the thickness of the filter, which at least has to be as thick as the width W. The length of the array, L, on the other hand, can be larger as long as it does not exceed the length of the entire filter. There are several common standards for filter thickness, and in some embodiments, the array segments can be designed to meet such standards or similar standards. Among the common standards for low performance filters, a thickness T (FIG. 1A) of 10 mm and 25 mm (or 1 inch) are common. Higher performance filters are commonly available at thicknesses T of approximately 50 mm (2″), 100 mm (4″) and 200 mm (8″). The array segment itself may need to be slightly less than the target filter thickness, to allow for the inter-segment connecting barriers or the frame itself. In some embodiments, the width of the array disclosed herein can be configured so as to allow filters with thickness ranging from 10 mm to 200 mm, from 20 mm to 150 mm, from 25 mm to 150 mm, from 50 mm to 125 mm, from 50 mm to 100 mm, 75 mm, including values and subranges therebetween.

In this stack configuration, the stacking density is limited by the height of the cyclonic elements 240, including the receptacle 260. This presents a partial tradeoff between the overall number of elements 240, which can determine the total airflow through the filter, and the depth of the receptacles 260, which can affect the filter operating life as explained above.

FIG. 8B shows a side view of a segmented array filter 272 where each segment is approximately at a 45-degree angle relative to the filter plane. Any other angle including angles in the range from 0 degree to 90 degrees, from 10 degrees to 75 degrees, from 20 degrees to 60 degrees, from 25 degree to 60 degree, from 30 degrees to 45 degrees, can be realized using this approach.

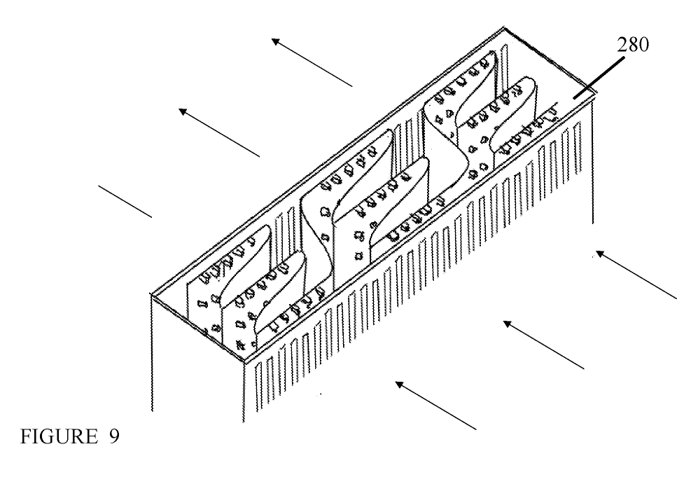

A variation of the stack configuration can be also utilized when the intended filter orientation is horizontal and therefore parallel (or approximately parallel) to the array sheets/members. Such a configuration is shown in FIG. 9. The filter comprises multiple stacks where each stack comprises several parallel array segments, and the multiple stacks are placed side by side to form the entire filter 280. In FIG. 9, each stack is shown to comprise three parallel array sections. In some embodiments, the stacked may comprise more or less array sections (e.g., two, one, four, five, six, etc., array sections). The advantage of this configuration over the simple in-plane configuration is the ability to increase the aggregate number of cyclonic elements in a filter of given size, while still allowing the filter orientation to be horizontal. In this embodiment, barriers are configured such that air enters the filter vertically, between the stacks, then guided to flow horizontally underneath each array in the stack, from where it proceeds to flow into the cyclonic inlets, through the cavities and the outlets, above each array and finally to the other side of the stack and up between the neighboring stacks. Vertical and horizontally being relative (same applies as to other references to vertical and horizontal, as well as any other directional description—up, down, right, left)

The cyclonic element arrays can be made of any suitable material including plastics, metal, ceramics, glass, paper, fiber, composites and any other material that can be molded, shaped, stamped, machined, etched, carved, printed or otherwise formed into the required structure, including additive manufacturing such as 3-dimensional printing.

In some embodiments, the manufacture of an array is achieved in part by attaching a number of layers (formed separately) and, when attached in the designed manner, form the required cavities and inlets. In one embodiment, the layers are made of a plastic or polymer, such as, but not limited to, polyethylene, polypropylene, polystyrene, polycarbonate, PVC, PTFE or any other suitable plastic. Each layer can be formed using plastic manufacturing techniques including but not limited to injection molding, thermoforming or vacuum forming and/or additive manufacturing/3d-printing. Different layers can be formed using different processes. For example, one layer can be made with vacuum forming and attached to another layer made with injection molding. Different layers may be made of different materials and can be attached using adhesives, welding or simply a mechanical attachment that is secured by mating features in adjacent layers.

Arrays can be mass-produced in one or more standardized sizes, and a variety of filter sizes can be made from the mass produced array modules either by attaching a plurality of smaller sections or by cutting a larger sheet into smaller pieces that match the design of the filter required.

The dimensions and precise structure of the individual cyclonic elements can be modified to meet the requirements of different applications. Smaller diameter cavities will generally have better ability to capture finer particles.

While various inventive embodiments have been described and illustrated herein, those of ordinary skill in the art will readily envision a variety of other means and/or structures for performing the function (or forming the structure) and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be an example and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is therefore to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure and can be further embodiments. Some embodiments may be distinguishable from the prior art for specifically lacking one or more features/elements/functionality (i.e., claims directed to such embodiments may include negative limitations).

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1-22. (canceled)

23. A replacement cyclonic air filter configured for replacing a standard fibrous air filter in a building ventilation system, the cyclonic air filter comprising:
a rectangular frame or housing configured for removable insertion into a building ventilation system in place of a standard fibrous air filter;
a plurality of cyclonic element arrays arranged within the frame or housing, each array comprising:
a plurality of cyclonic-elements configured to filter particles from an airflow received from the building ventilation system, wherein each respective cyclonic element comprises:
a symmetrical, cone-shaped cavity having a tangential airflow inlet and a single axial airflow outlet, a particle outlet configured to receive and direct particles from the cavity separated from the airflow, each arranged at a first end of the cyclonic element,
and
a sealed, individual particle receptacle arranged at a second end of the cyclonic element, the receptacle being in communication with the particle outlet and configured to receive particles filtered from the airflow;
a common sheet attached to the plurality of cyclonic elements at the first end, the sheet configured:
to at least one of prevent air from flowing through the array except via the plurality of cyclonic elements and to organize the plurality of cyclonic elements,
and
form a surface along a plane which includes a respective opening for each axial airflow outlet to allow the airflow therefrom to pass;
and
a plurality of individual airflow paths corresponding to the plurality individual of cyclone elements in each array,
wherein:
each array includes an upstream side configured for receiving the airflow, and a downstream side including the common sheet and separated from the upstream side via at least the common sheet,
the tangential airflow inlet and the axial airflow outlet of each cyclonic element of each array are both arranged adjacent the common sheet side of the array,
the particle outlet and the receptacle are arranged adjacent the upstream side of the array,
and
each airflow path corresponds to a respective cyclone element and comprises a path established from:
the upstream side of the array, followed by,
receipt by a tangential airflow inlet adjacent the common sheet side of the array,
through a respective cavity, and
out a respective airflow outlet adjacent the downstream side of the array.

24. The filter of claim 23, wherein a depth h of each receptacle is between 2-50 mm.

25. The filter of claim 23, wherein a depth h of each receptacle is between 3-20 mm.

26. The filter of claim 23, wherein the filter further includes a thickness T between approximately 10 mm-200 mm.

27. The filter of claim 23, wherein an inner diameter d of a base of the cavity is less than 10 mm.

28. The filter of claim 23, wherein an inner diameter d of a base of the cavity is less than 5 mm.

29. The filter of claim 23, wherein an inner diameter d of a base of the cavity is less than 2 mm.

30. The filter of claim 23, wherein the filter includes no other airflow pathways other than the plurality of individual airflow paths.
